(19) United States
(12) Patent Application Publication
(10) Pub. No.: US 2026/0161008 A1
(43) Pub. Date: Jun. 11, 2026

(54) Lens Driving Device

(71) Applicant: AAC Microtech (Changzhou) Co., Ltd., Changzhou City (CN)

(72) Inventors: Zhang Ren, Changzhou (CN); Ronglin Linghu, Changzhou (CN); Suohe Wei, Changzhou (CN); Bo Xiao, Changzhou (CN)

(21) Appl. No.: 19/048,821

(22) Filed: Feb. 7, 2025

Related U.S. Application Data
(63) Continuation of application No. PCT/CN2024/138486, filed on Dec. 11, 2024.

(51) Int. Cl. G02B 27/64; G03B 5/00

(52) U.S. Cl. CPC G02B 27/646; G03B 5/00; G03B 2205/0069

(57) ABSTRACT

A lens driving device includes a housing having a bottom plate, a first holder capable of moving relative to the bottom plate, a second holder capable of moving relative to the first holder for holding a lens assembly, a first driving unit, a guiding rod and a second driving unit. The first driving unit includes a first magnetic circuit system fixed to the first holder and a driving coil fixed to the second holder. The guiding rod is fixed to the first holder and forms a sliding connection with the second holder. The second driving unit includes a second magnetic circuit system and an anti-shake coil. The lens driving device improves the driving force of the first magnetic circuit system driving the lens assembly, and the guiding rod can prevent the lens assembly from tilting when the lens assembly moves along its optical axis.

### FIELD OF THE PRESENT DISCLOSURE

The present disclosure relates to shooting devices, in particular to a lens driving device.

### DESCRIPTION OF THE RELATED ART

With the improvement of living standards, some devices with the shooting function, such as digital cameras, digital video cameras, smart phones, tablet computers, have been equipped with autofocus cameras, and the autofocus cameras needs a lens driving device to drive, in order to realize autofocus and optical anti-shake.

A lens driving device in the related art includes a housing, a first holder, a second holder spaced apart from the first holder, a lens assembly with an optical axis held by the second holder and a driving unit for driving the lens assembly to move along the optical axis or along a direction perpendicular to the optical axis. The driving unit mainly includes a common magnetic circuit system and a focusing coil and an anti-shake coil that are driven by the common magnetic circuit system.

However, the common magnetic circuit system uses an open-loop magnetic circuit, which leads to insufficient driving force when the common magnetic circuit system drives the lens assembly to move along the optical axis. Besides, when the lens assembly moves along the optical axis, the lens assembly often tilts.

### SUMMARY

An objective of the present disclosure is to provide a novel lens driving device to solve the above problems.

In order to achieve the objective mentioned above, the present disclosure discloses a lens driving device including a housing, a first holder, a lens assembly with an optical axis, a second holder holding the lens assembly, a first driving unit, a guiding rod and a second driving unit. The housing includes a bottom plate and an upper cover engaged with the bottom plate for enclosing a containment space. The upper cover is provided with a light-through hole communicating the containment space and the outside. The first holder is in a rectangular ring shape, which locates in the containment space and is capable of moving relative to the bottom plate. The second holder is aligned with the light-through hole, which locates in the first holder and is capable of moving relative to the first holder. The first driving unit drives the second holder to move relative to the first holder along a direction of the optical axis and includes a first magnetic circuit system fixed to the first holder and a driving coil fixed to the second holder. The first magnetic circuit system includes a magnetic frame provided with an opening end and fixed to the first holder, a magnet unit located in the magnetic frame, and a top plate fixed to the opening end of the magnetic frame. The magnetic frame is provided with two notches extending along the direction of the optical axis. The driving coil locates in the magnetic frame and is sleeved on the magnet unit. The second holder is provided with two clamping arms respectively entering the magnetic frame through the two notches and fixed to the driving coil. The guiding rod extends along the direction of the optical axis, which is fixed to the first holder and spaced apart from the first driving unit. The guiding rod forms a sliding connection with the second holder and guides the second holder to move along the direction of the optical axis. The second driving unit drives the first holder to move relative to the bottom plate along a direction perpendicular to the optical axis and includes a second magnetic circuit system and an anti-shake coil facing the second magnetic circuit system. The second magnetic circuit system is fixed to one of the bottom plate and the first holder, and the anti-shake coil is fixed to the other of the bottom plate and the first holder.

As an improvement, an amount of the first driving unit is one, and an amount of the guiding rod is one, the first driving unit and the guiding rod are respectively arranged at two opposite corners of the first holder; an amount of the second driving units is four, and the four second driving units are divided into two groups, the two groups are respectively arranged at another two opposite corners of the first holder, each group includes two second driving units respectively arranged at two adjacent sides of the first holder.

As an improvement, the first holder includes a first side, a second side, a third side and a fourth side that are connected in sequence; an amount of the first driving unit is one, and the first driving unit is arranged at a corner formed by the first side and the second side; an amount of the guiding rods is three, and the three guiding rods include a first guiding rod, a second guiding rod and a third guiding rod, the first guiding rod is arranged at a corner formed by the second side and the third side, the second guiding rod is arranged at a corner formed by the third side and the fourth side, the third guiding rod is arranged at a middle of the first side; an amount of the second driving units is two, and the two second driving units are respectively arranged at the third side and the fourth side.

As an improvement, an amount of the first driving units is two, and the two first driving units are respectively arranged at two opposite corners of the first holder; an amount of the guiding rods is two, and the two guiding rods are respectively arranged at another two opposite corners of the first holder; an amount of the second driving units is two, and the two second driving units are respectively arranged at two adjacent sides of the first holder.

As an improvement, an amount of the first driving units is two, and the two first driving units are respectively arranged at two opposite corners of the first holder; an amount of the guiding rods is two, and the two guiding rods are respectively arranged at two opposite sides of the first holder, each guiding rod is arranged at a middle of the corresponding side of the first holder; an amount of the second driving units is two, and the two second driving units are respectively arranged at another two opposite corners of the first holder.

As an improvement, the magnetic frame includes a bottom wall and a side wall bending from the bottom wall, the side wall is provided with the two notches, the magnet unit includes a first driving magnet stacked on the bottom wall, a yoke stacked on the first driving magnet and a second driving magnet stacked on the yoke, the top plate is stacked on the second driving magnet.

As an improvement, a part of the first holder close to the bottom plate extends inward to form a support part spaced apart from the bottom plate, a support plate is fixed to another part of the first holder far away from the bottom plate and faces the support part, the second holder extends outward to form an extension part with a through hole, the guiding rod passes through the through hole for forming the sliding connection with the second holder, one end of the guiding rod is fixed to the support plate, another end of the guiding rod is inserted into and fixed to the support part.

As an improvement, the second magnetic circuit system includes a bottom yoke fixed to the bottom plate and a first anti-shake magnet, a second anti-shake magnet and a third anti-shake magnet that are stacked on the bottom yoke and arranged in sequence along the direction perpendicular to the optical axis, the second anti-shake magnet connects the first anti-shake magnet and the third anti-shake magnet.

As an improvement, the lens driving device further includes a first elastic member connecting the first holder and the bottom plate.

As an improvement, the lens driving device further includes a second elastic member and a third elastic member. The second elastic member connects a top of the first holder far away from the bottom plate and a top of the second holder far away from the bottom plate, the third elastic member connects a bottom of the first holder close to the bottom plate and a bottom of the second holder close to the bottom plate.

Compared with the related art, the lens driving device according to the present disclosure decouples the first driving unit and the second driving unit, further the first magnetic circuit system of the first driving unit is designed as a closed magnetic circuit, as well as providing the guiding rod fixed to the first holder and forming a sliding connection with the second holder. The closed magnetic circuit improves the driving force of the first magnetic circuit system driving the lens assembly to move along the optical axis, furthermore, the guiding rod can guide the second holder to move, thereby preventing the lens assembly from tilting when the lens assembly moves along the optical axis.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is an isometric view of a lens driving device provided by the first embodiment of the present disclosure.

FIG. 2 is a partial exploded view of the lens driving device provided by the first embodiment of the present disclosure.

FIG. 3 is a cross-sectional view of the lens driving device, taken along line A-A in FIG. 1.

FIG. 4 is a cross-sectional view of the lens driving device, taken along line B-B in FIG. 1.

FIG. 5 is a schematic diagram of the amount and the positions relative to a bottom plate of a first driving unit, a guiding rod and a second driving unit of the lens driving device provided by the first embodiment of the present disclosure.

FIG. 6 is a schematic diagram of the amount and the positions relative to a bottom plate of a first driving unit, a guiding rod and a second driving unit of a lens driving device provided by the second embodiment of the present disclosure.

FIG. 7 is a schematic diagram of the amount and the positions relative to a bottom plate of a first driving unit, a guiding rod and a second driving unit of a lens driving device provided by the third embodiment of the present disclosure.

FIG. 8 is a schematic diagram of the amount and the positions relative to a bottom plate of a first driving unit, a guiding rod and a second driving unit of a lens driving device provided by the fourth embodiment of the present disclosure.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

### First Embodiment

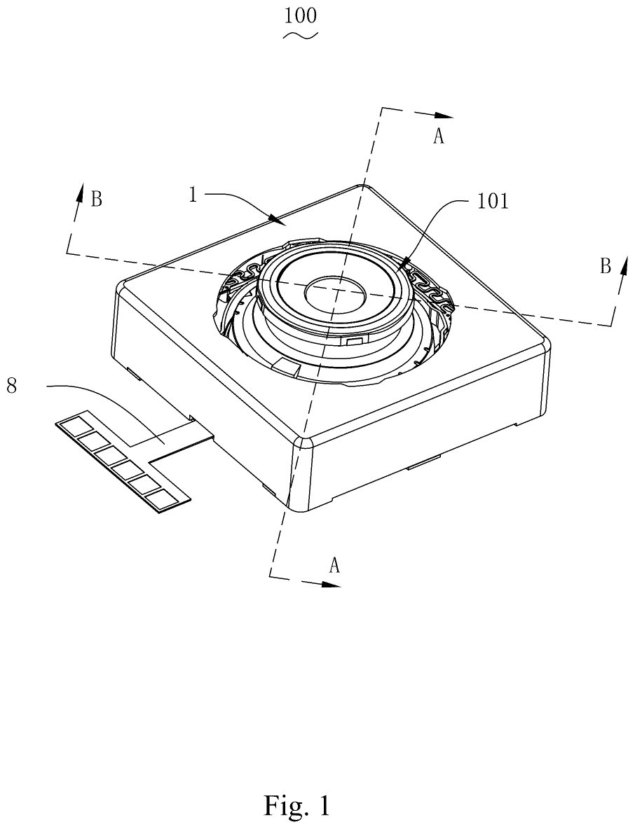

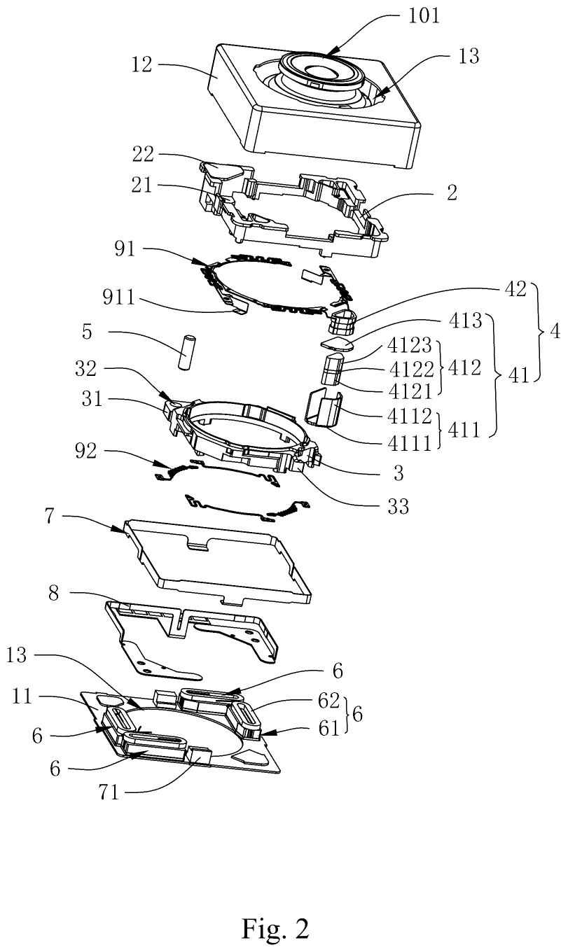

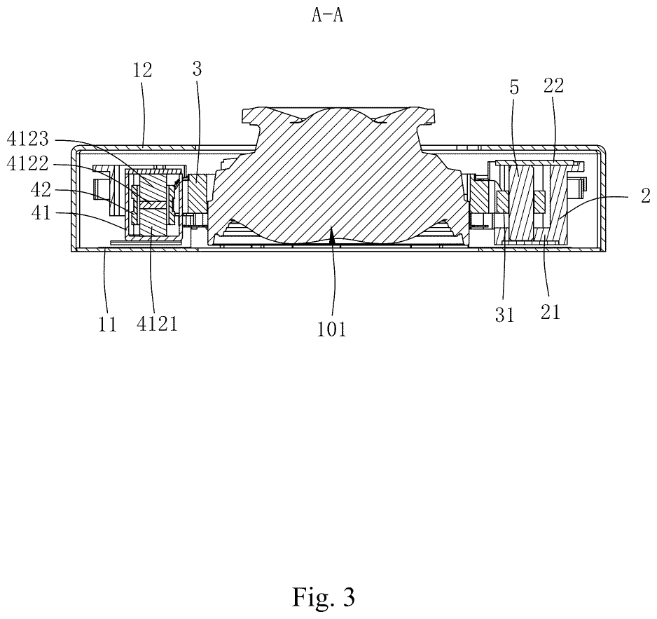

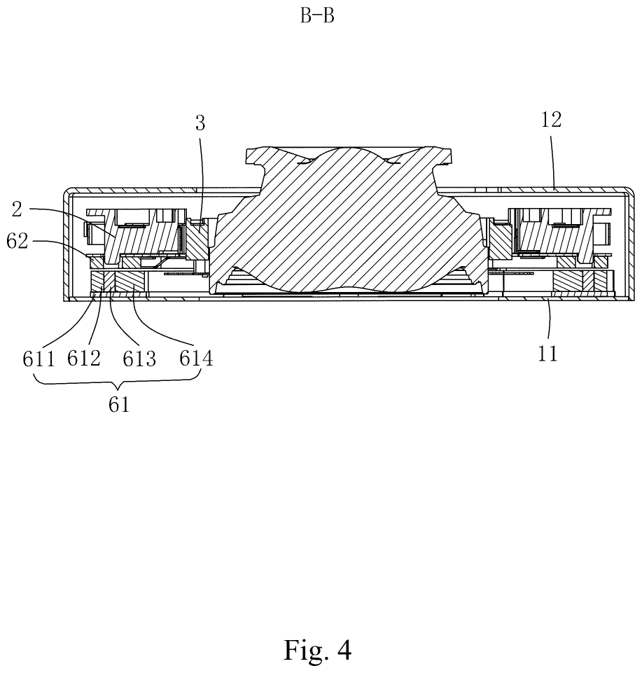

Referring to FIGS. 1-4, the first embodiment of the present disclosure discloses a lens driving device 100 including a housing 1, a first holder 2, a second holder 3, a first driving unit 4, a guiding rod 5 and a second driving unit 6.

The housing 1 includes a bottom plate 11 and an upper cover 12 engaged with the bottom plate 11 for enclosing a containment space. The upper cover 12 is provided with a light-through hole 13 communicating the containment space and the outside. The first holder 2 is in a rectangular ring shape, which locates in the containment space and is capable of moving relative to the bottom plate 11. The second holder 3 is aligned with the light-through hole 13 for holding a lens assembly 101 with an optical axis, which locates in the first holder 2 and is capable of moving relative to the first holder 2.

Optionally, the bottom plate 11 may be also provided with another light-through hole to communicate the containment space and the outside.

The first driving unit 4 drives the second holder 3 to move relative to the first holder 2 along a direction of the optical axis. The guiding rod 5 is fixed to the first holder 2 and extends along the direction of the optical axis. The guiding rod 5 forms a sliding connection with the second holder 3 and guides the second holder 3 to move along the direction of the optical axis. The second driving unit 6 drives the first holder 2 to move relative to the bottom plate 11 along a direction perpendicular to the optical axis.

The first driving unit 4 includes a first magnetic circuit system 41 fixed to the first holder 2 and a driving coil 42 fixed to the second holder 3. The first magnetic circuit system 41 includes a magnetic frame 411 provided with an opening end and fixed to the first holder 2, a magnet unit 412 located in the magnetic frame 411, and a top plate 413 fixed to the opening end of the magnetic frame 411. The magnetic frame 411 is provided with two notches extending along the direction of the optical axis. The driving coil 42 locates in the magnetic frame 411 and is sleeved on the magnet unit 412. The second holder 3 is provided with two clamping arms 33 respectively entering the magnetic frame 411 through the two notches and fixed to the driving coil 42.

The magnetic frame 411 includes a bottom wall 4111 and a side wall 4112 bending from the bottom wall 4111, the side wall 4112 is provided with the two notches, the magnet unit 412 includes a first driving magnet 4121 stacked on the bottom wall 4111, a yoke 4122 stacked on the first driving magnet 4121 and a second driving magnet 4123 stacked on the yoke 4122, the top plate 413 is stacked on the second driving magnet 4123.

A part of the first holder 2 close to the bottom plate 11 extends inward to form a support part 21 spaced apart from the bottom plate 11, a support plate 22 is fixed to another part of the first holder 2 far away from the bottom plate 11 and faces the support part 21, the second holder 3 extends outward to form an extension part 31 with a through hole 32, the guiding rod 5 passes through the through hole 32 for forming the sliding connection with the second holder 3, one end of the guiding rod 5 is fixed to the support plate 22, another end of the guiding rod 5 is inserted into and fixed to the support part 21, thereby, the guiding rod 5 can be fixed to the first holder 2 firmly.

The second driving unit 6 includes a second magnetic circuit system 61 fixed to the bottom plate 11 and an anti-shake coil 62 fixed to the first holder 2 and facing the second magnetic circuit system 61. Instead, according to actual requirements, the second magnetic circuit system 61 may be fixed to the first holder 2, and the anti-shake coil 62 may be fixed to the bottom plate 11.

The second magnetic circuit system 61 includes a bottom yoke 611 fixed to the bottom plate 11 and a first anti-shake magnet 612, a second anti-shake magnet 613 and a third anti-shake magnet 614 that are stacked on the bottom yoke 611 and arranged in sequence along the direction perpendicular to the optical axis, the second anti-shake magnet 613 connects the first anti-shake magnet 612 and the third anti-shake magnet 614.

The lens driving device 100 further includes a first elastic member 7 connecting the first holder 2 and the bottom plate 11. An amount of the first elastic members 7 is two, and the two first elastic members 7 are respectively arranged at two opposite sides of the first holder 2, each first elastic member 7 is connected to the bottom plate 11 through a support member 71.

The lens driving device 100 further includes a flexible circuit board 8 fixed to one of the two first elastic members 7 and electrically connected to the anti-shake coil 62. The flexible circuit board 8 extends outward through the upper cover 12.

The lens driving device 100 further includes a second elastic member 91 and a third elastic member 92 spaced apart from each other. The second elastic member 91 connects a top of the first holder 2 far away from the bottom plate 11 and a top of the second holder 3 far away from the bottom plate 11, the third elastic member 92 connects a bottom of the first holder 2 close to the bottom plate 11 and a bottom of the second holder 3 close to the bottom plate 11.

The driving coil 42 is electrically connected to the second elastic member 91, and the second elastic member 91 is electrically connected to the flexible circuit board 8 through a metal connector 911, thereby, the driving coil 42 is also electrically connected to the flexible circuit board 8.

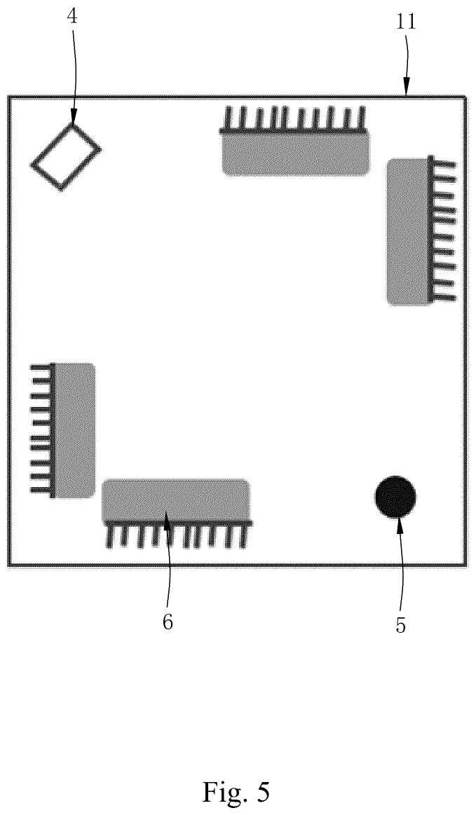

Referring to FIG. 5, an amount of the first driving unit 4 is one, and an amount of the guiding rod 5 is one, the first driving unit 4 and the guiding rod 5 are respectively arranged at two opposite corners of the first holder 2; an amount of the second driving units 6 is four, and the four second driving units 6 are divided into two groups, the two groups are respectively arranged at another two opposite corners of the first holder 2, each group includes two second driving units 6 respectively arranged at two adjacent sides of the first holder 2.

Compared with the related art, the lens driving device 100 according to the present disclosure decouples the first driving unit 4 and the second driving unit 6, further the first magnetic circuit system 41 of the first driving unit 4 is designed as a closed magnetic circuit, as well as providing the guiding rod 5 fixed to the first holder 2 and forming a sliding connection with the second holder 3. The closed magnetic circuit improves the driving force of the first magnetic circuit system 41 driving the lens assembly 101 to move along the optical axis, furthermore, the guiding rod 5 can guide the second holder 3 to move, thereby preventing the lens assembly 101 from tilting when the lens assembly 101 moves along the optical axis.

### Second Embodiment

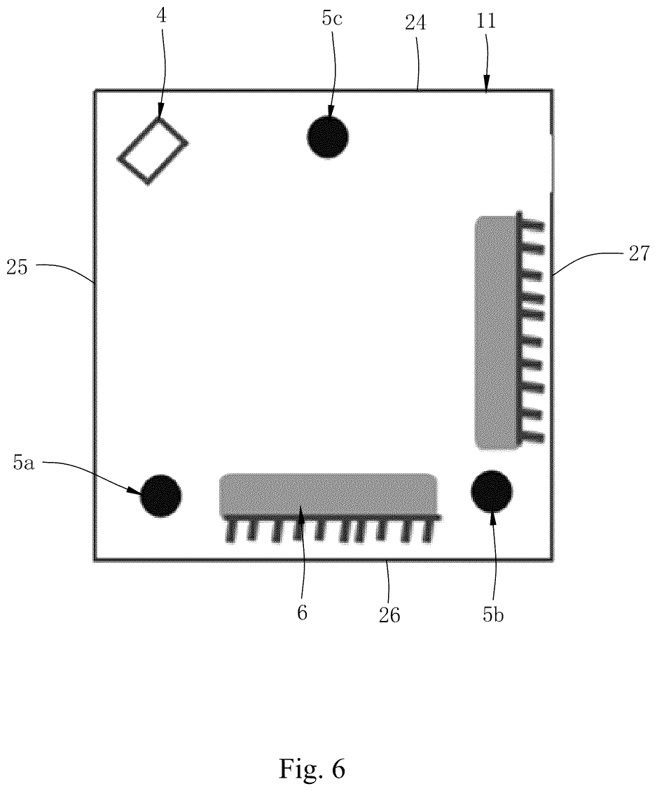

The second embodiment differs from the first embodiment in that, referring to FIG. 6, the first holder 2 includes a first side 24, a second side 25, a third side 26 and a fourth side 27 that are connected in sequence; an amount of the first driving unit 4 is one, and the first driving unit 4 is arranged at a corner formed by the first side 24 and the second side 25; an amount of the guiding rods 5 is three, and the three guiding rods 5 include a first guiding rod 5a, a second guiding rod 5b and a third guiding rod 5c, the first guiding rod 5a is arranged at a corner formed by the second side 25 and the third side 26, the second guiding rod 5b is arranged at a corner formed by the third side 26 and the fourth side 27, the third guiding rod 5c is arranged at a middle of the first side 24; an amount of the second driving units 6 is two, and the two second driving units 6 are respectively arranged at the third side 26 and the fourth side 27.

### Third Embodiment

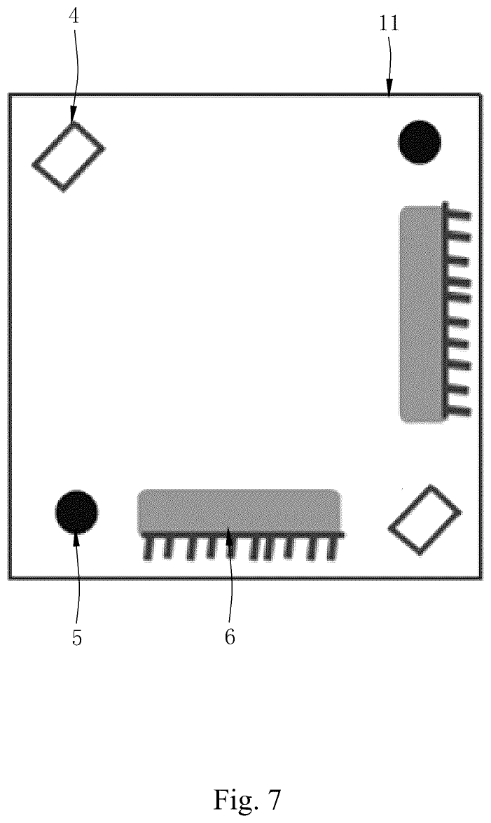

The third embodiment differs from the first embodiment in that, referring to FIG. 7, an amount of the first driving units 4 is two, and the two first driving units 4 are respectively arranged at two opposite corners of the first holder 2; an amount of the guiding rods 5 is two, and the two guiding rods 5 are respectively arranged at another two opposite corners of the first holder 2; an amount of the second driving units 6 is two, and the two second driving units 6 are respectively arranged at two adjacent sides of the first holder 2.

### Fourth Embodiment

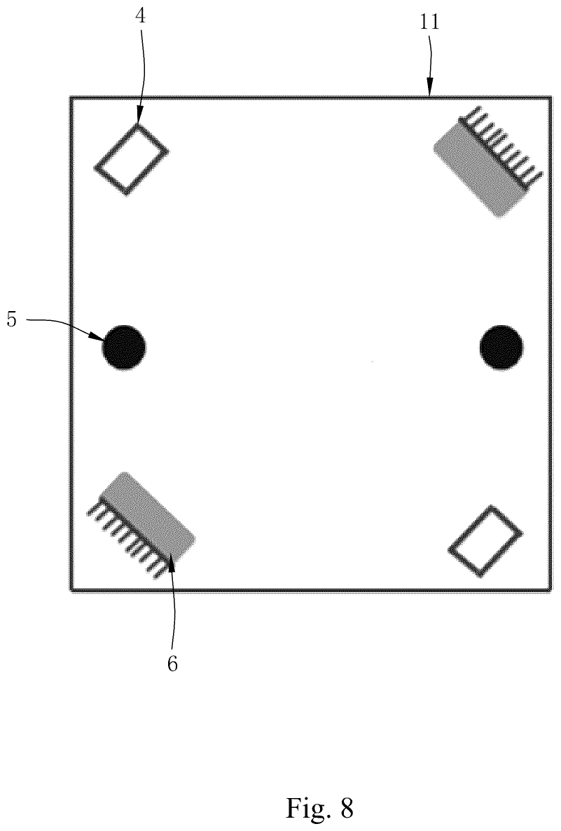

The fourth embodiment differs from the first embodiment in that, referring to FIG. 8, an amount of the first driving units 4 is two, and the two first driving units 4 are respectively arranged at two opposite corners of the first holder 2; an amount of the guiding rods 5 is two, and the two guiding rods 5 are respectively arranged at two opposite sides of the first holder 2, each guiding rod 5 is arranged at a middle of the corresponding side of the first holder 2; an amount of the second driving units 6 is two, and the two second driving units 6 are respectively arranged at another two opposite corners of the first holder 2.

Optionally, according to the size of the lens driving device, the amount and the positions of the first driving unit 4, the guiding rod 5 and the second driving unit 6 can also be designed in other manners.

The above are only embodiments of the present disclosure. It should be pointed out that those of ordinary skill in the art may also make improvements without departing from the ideas of the present disclosure, all of which fall within the protection scope of the present disclosure.

What is claimed is:

1. A lens driving device, comprising:
a housing, comprising a bottom plate and an upper cover engaged with the bottom plate for enclosing a containment space, wherein the upper cover is provided with a light-through hole communicating the containment space and the outside;
a first holder in a rectangular ring shape, located in the containment space and capable of moving relative to the bottom plate;
a lens assembly with an optical axis;
a second holder aligned with the light-through hole for holding the lens assembly, located in the first holder and capable of moving relative to the first holder;
a first driving unit, driving the second holder to move relative to the first holder along a direction of the optical axis and comprising a first magnetic circuit system fixed to the first holder and a driving coil fixed to the second holder, wherein the first magnetic circuit system comprises a magnetic frame provided with an opening end and fixed to the first holder, a magnet unit located in the magnetic frame, and a top plate fixed to the opening end of the magnetic frame; the magnetic frame is provided with two notches extending along the direction of the optical axis; the driving coil locates in the magnetic frame and is sleeved on the magnet unit; the second holder is provided with two clamping arms respectively entering the magnetic frame through the two notches and fixed to the driving coil;
a guiding rod extending along the direction of the optical axis, fixed to the first holder and spaced apart from the first driving unit, wherein the guiding rod forms a sliding connection with the second holder and guides the second holder to move along the direction of the optical axis; and
a second driving unit, driving the first holder to move relative to the bottom plate along a direction perpendicular to the optical axis and comprising a second magnetic circuit system and an anti-shake coil facing the second magnetic circuit system, wherein the second magnetic circuit system is fixed to one of the bottom plate and the first holder, and the anti-shake coil is fixed to the other of the bottom plate and the first holder.

2. The lens driving device as described in claim 1, wherein an amount of the first driving unit is one, and an amount of the guiding rod is one, the first driving unit and the guiding rod are respectively arranged at two opposite corners of the first holder; an amount of the second driving units is four, and the four second driving units are divided into two groups, the two groups are respectively arranged at another two opposite corners of the first holder, each group comprises two second driving units respectively arranged at two adjacent sides of the first holder.

3. The lens driving device as described in claim 1, wherein the first holder comprises a first side, a second side, a third side and a fourth side that are connected in sequence; an amount of the first driving unit is one, and the first driving unit is arranged at a corner formed by the first side and the second side; an amount of the guiding rods is three, and the three guiding rods comprise a first guiding rod, a second guiding rod and a third guiding rod, the first guiding rod is arranged at a corner formed by the second side and the third side, the second guiding rod is arranged at a corner formed by the third side and the fourth side, the third guiding rod is arranged at a middle of the first side; an amount of the second driving units is two, and the two second driving units are respectively arranged at the third side and the fourth side.

4. The lens driving device as described in claim 1, wherein an amount of the first driving units is two, and the two first driving units are respectively arranged at two opposite corners of the first holder; an amount of the guiding rods is two, and the two guiding rods are respectively arranged at another two opposite corners of the first holder; an amount of the second driving units is two, and the two second driving units are respectively arranged at two adjacent sides of the first holder.

5. The lens driving device as described in claim 1, wherein an amount of the first driving units is two, and the two first driving units are respectively arranged at two opposite corners of the first holder; an amount of the guiding rods is two, and the two guiding rods are respectively arranged at two opposite sides of the first holder, each guiding rod is arranged at a middle of the corresponding side of the first holder; an amount of the second driving units is two, and the two second driving units are respectively arranged at another two opposite corners of the first holder.

6. The lens driving device as described in claim 1, wherein the magnetic frame comprises a bottom wall and a side wall bending from the bottom wall, the side wall is provided with the two notches, the magnet unit comprises a first driving magnet stacked on the bottom wall, a yoke stacked on the first driving magnet and a second driving magnet stacked on the yoke, the top plate is stacked on the second driving magnet.

7. The lens driving device as described in claim 1, wherein a part of the first holder close to the bottom plate extends inward to form a support part spaced apart from the bottom plate, a support plate is fixed to another part of the first holder far away from the bottom plate and faces the support part, the second holder extends outward to form an extension part with a through hole, the guiding rod passes through the through hole for forming the sliding connection with the second holder, one end of the guiding rod is fixed to the support plate, another end of the guiding rod is inserted into and fixed to the support part.

8. The lens driving device as described in claim 1, wherein the second magnetic circuit system comprises a bottom yoke fixed to the bottom plate and a first anti-shake magnet, a second anti-shake magnet and a third anti-shake magnet that are stacked on the bottom yoke and arranged in sequence along the direction perpendicular to the optical axis, the second anti-shake magnet connects the first anti-shake magnet and the third anti-shake magnet.

9. The lens driving device as described in claim 1 further comprising a first elastic member connecting the first holder and the bottom plate.

10. The lens driving device as described in claim 1 further comprising a second elastic member and a third elastic member, wherein the second elastic member connects a top of the first holder far away from the bottom plate and a top of the second holder far away from the bottom plate, the third elastic member connects a bottom of the first holder close to the bottom plate and a bottom of the second holder close to the bottom plate.
